(19) United States
(12) Patent Application Publication
(10) Pub. No.: US 2007/0103812 A1
(43) Pub. Date: May 10, 2007

(54) Magnetic head closure bond using metal adhesion

(76) Inventors: Robert G. Biskeborn, Hollister, CA (US); Icho E. Iben, Santa Clara, CA (US); Andrew C. Ting, El Prado, NM (US)

Correspondence Address: WALTER W. DUFT, 8616 MAIN STREET, SUITE 2, WILLIAMSVILLE, NY, 14221, US

(21) Appl. No.: 11/271,417

(22) Filed: Nov. 9, 2005

(51) Int. Cl. G11B 5/187; G11B 5/147

(52) U.S. Cl. 360/122; 360/126

(57) ABSTRACT

A transducing head and related fabrication method, and a system for information storage. The head includes a substrate comprising a relatively hard material, a transducer carrier on the substrate comprising a material that is soft relative to the substrate and which embeds one or more transducer elements, and a closure on the transducer carrier comprising a relatively hard material. A metal-to-metal interconnection secures the carrier to the transducer carrier.

### BACKGROUND OF THE INVENTION

1. Field of the Invention

This invention relates to information storage. More particularly, the invention is directed to thin film magnetic heads for reading and/or writing data on magnetically encodable media, such as tape.

2. Description of the Prior Art

By way of background, transducing heads for magnetic information storage systems (e.g., tape drives) have been constructed using thin film techniques. A characteristic of such construction is that the thin film layers which comprise the active transducing elements (read elements, write elements or a combination of both) are embedded in a relatively soft “glassy” material (such as alumina) which has been deposited onto a hard substrate material. The soft material is typically alumina (Al₂O₃) and the hard material is typically an aluminum oxide-titanium carbide (Al₂O₃—TiC or AlTiC) ceramic. In applications where the head physically contacts the media, such as tape drives, a hard material block known as a “closure” is often bonded onto the outermost (“overcoat”) layer of the soft material that embeds the active elements. This sandwiches the active elements and surrounding soft material between two hard materials (the head substrate and the closure), thereby protecting against tape wear and providing a flat transducing surface. Like the head substrate, the closure commonly comprises an AlTiC ceramic, although magnetic ferrite materials may also be used.

Conventional assembly techniques call for the use of thermosetting adhesives to bond the closure to the head's soft overcoat layer. Although such adhesives generally fulfill their purpose, there are several concerns with this technique. First, adhesive bond integrity can degrade with age and when attacked by humidity. For example, commonly used thermoset adhesives may have a glass transition temperature of 90° C. (dry) but only 70° C. (wet). If the head operating temperature approaches the glass transition temperature, sliding movement of the closure relative to the soft material in which the read/write elements are embedded (creep) can result in a condition known as gap slip, in which the transducing elements move away from the media. Second, humidity adsorption by the adhesive or differential thermal expansion of the adhesive and the solid bond pieces can also cause gap slip. For high density magnetic tape storage systems, gap slip on the order of 10 nm can cause severe signal loss due to the phenomenon of Wallace spacing losses. Another issue associated with adhesive bonding of the closure is that humidity can also attack the bond interface between the adhesive and the solid materials being bonded, weakening the strength of the bonds. With extended exposure, the bonds can become so weak that the parts separate. A further disadvantage of thermosetting adhesives is that the low glass transition temperature may require that costly ultrasonic bonding techniques and compatible components be used to bond wire leads to bonding pads on the head. Potentially less costly techniques such as hot compression bonding with or without using Anisotropic Conductive Film (ACF) may be precluded insofar as the applied heat and compression could soften the adhesive and allow the components to move.

Accordingly, it is desired to have an improved design for a thin film transducing head for reading and/or writing data on magnetically encodable media.

### SUMMARY OF THE INVENTION

The foregoing problems are solved and an advance in the art is obtained by a novel transducing head and related fabrication method, and a system for information storage. The transducing head includes a substrate comprising a relatively hard material, a transducer carrier on the substrate comprising a deposited material that embeds one or more transducer elements and which is soft relative to the substrate, a closure on the transducer carrier comprising a relatively hard material, and a metal-to-metal interconnection securing the closure to the transducer carrier. The closure may comprise relatively hard material only, or it may comprise a first layer of relatively soft material on a second layer of relatively hard material, with the first closure layer supporting the metal-to-metal interconnection.

According to exemplary alternative embodiments of the invention, the metal-to-metal interconnection may comprise a first metal layer on the transducer carrier and a second metal layer on the closure, with the first and second metal layers being fused together. If desired, a metal solder bond material may be placed between the first and second metal layers to assist in fusing these layers together, or the solder bond material can be used to provide the metal layers. The solder material can be selected from the group consisting of solder paste, sheet solder and solder depositions. Plural solder layers may be used. One example would be a multi-layer solder comprising a pair of outer solder bond material layers sandwiching reactive laminate layers which melt when sufficient current is passed through them. The heat generated will then melt the reactive layers, enabling the bonding. A tinning material may be used with the solder bond material to improve adhesion.

In cases where the substrate and the closure materials are electrically conductive (such as AlTiC), a conductive connector may be formed to extend through the transducer carrier, which electrically connects the substrate to the closure through the interconnection metal(s). If the closure comprises a layer of soft, electrically insulating material (such as alumina), another conductive connector can be formed to extend through the closure first layer and electrically connect the closure second layer to the interconnection.

### BRIEF DESCRIPTION OF THE DRAWINGS

The foregoing and other features and advantages of the invention will be apparent from the following more particular description of exemplary embodiments of the invention, as illustrated in the accompanying Drawings, in which:

FIG. 1 is an exploded perspective view showing an exemplary transducing head constructed in accordance with the present invention, prior to attachment of the transducing head closure to the head's transducer carrier and substrate assembly;

FIG. 2 is a cross-sectional view taken along line 2-2 in FIG. 1 to illustrate exemplary transducing elements of the transducing head of FIG. 1;

FIG. 3 is a perspective view of the transducing head of FIG. 1, with the transducing head closure secured to the remainder of the head;

FIG. 4 is a side view showing a pair of the transducing heads of FIG. 1 mounted on a head support structure and engaging a magnetic tape;

FIG. 5 is an enlarged side view showing the formation of an exemplary metal-to-metal interconnection between a transducing head closure and a transducer carrier;

FIG. 6 is an enlarged side view showing the formation of modified version of the metal-to-metal interconnection of FIG. 5 in which solder material is used in the interconnection;

FIG. 6A is an enlarged side view showing a variation of the metal-to-metal interconnection of FIG. 6;

FIG. 7 is an enlarged side view showing an exemplary multilayer solder material that may be used in the assembly of FIG. 6;

FIG. 8 is an enlarged side view showing the formation of an exemplary metal-to-metal interconnection between a transducing head closure and a transducer carrier, together with a conductive conductor between the interconnection and a transducing head substrate;

FIG. 9 is an enlarged side view showing the formation of an exemplary metal-to-metal interconnection between a two-layer transducing head closure and a transducer carrier;

FIG. 10 is an enlarged side view showing the formation of an exemplary interconnection between a two-layer transducing head closure and a transducer carrier, together with conductive conductors between the interconnection and a transducing head substrate and between the interconnection and a substrate layer of the closure, respectively;

FIG. 11 is a functional block diagram showing a tape drive data storage device adapted for use with the transducing head of the present invention; and

FIG. 12 is a perspective view showing an exemplary construction of the tape drive storage device of FIG. 11 for use with cartridge-based tape media.

### DETAILED DESCRIPTION OF THE PREFERRED EMBODIMENT

The invention will now be described by way of exemplary embodiments shown by the drawing figures (which are not necessarily to scale), in which like reference numerals indicate like elements in all of the several views. Although the illustrated embodiments are specific to magnetic tape storage, it should be understood that the invention may also be applied to other magnetic storage systems, such as direct access storage device (DASD) systems, including but not necessarily limited to disk drives.

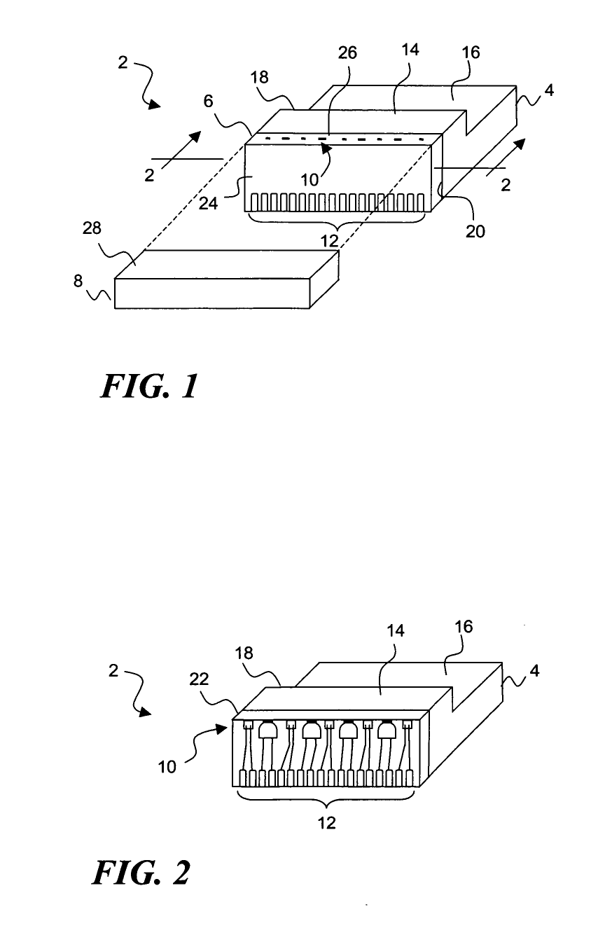

Turning now to FIG. 1, an exemplary transducing head 2 is constructed using thin-film techniques for linear recording and playback on a streaming magnetic tape medium (not shown in FIG. 1). The head 2 conventionally includes a substrate 4, a transducer carrier 6 on the substrate, and a closure 8 that is shown in FIG. 1 prior to its attachment to the transducer carrier. A set of transducers 10 are embedded in the transducer carrier 6 and receive electrical connections through a set of ultrasonic bonding pads 12 that are also supported by the transducer carrier 6.

The substrate 4 and at least a portion of the closure 8 are formed from a relatively hard material, such as AlTiC or the like. The transducer carrier 6 is formed from a relatively soft glassy material, such as alumina or the like. As used herein, the terms “relatively hard” and “relatively soft” are not intended to represent quantitative values, but are instead used qualitatively to refer to the comparative hardness of the substrate 4 and the closure 8, on one hand, relative to the transducer carrier 6, on the other hand. The actual hardness of the substrate 4, the transducer carrier 6 and the closure 8 may therefore vary according to the materials used.

The substrate 4 is formed with a tape bearing surface 14 that is adapted to engage a streaming tape medium T, as shown FIG. 4. A groove 16 in the substrate 4 defines an edge 18 for skiving air away from the head 2. This creates a vacuum under the tape T on the upstream side of the edge 18 (when the tape is moving toward the edge from off of the head 2) to hold it against the flat tape bearing surface 14. The hardness of the substrate 4 should be sufficient to enable it to withstand frictional wear caused by abrasions on the tape T, such that the tape bearing surface 14 will not appreciably degrade even after a long period of use. The above-mentioned AlTiC material is sufficient for this purpose, but other materials could no doubt also be used.

The transducer carrier 6 is deposited on an interfacial support surface 20 of the substrate 4 in a sequence of layers. As shown in FIG. 2, a sublayer 22 is first deposited to provide support for the transducers 10. The transducers 10 and an initial layer of the bonding pads 12 are then formed using conventional thin-film techniques. Various transducer arrangements may be used. FIG. 2 shows an exemplary array of read and write transducers, which are arranged in a linear side-by-side configuration. Note that one of the read transducers could be a servo reader. With the transducer configuration of FIG. 2, adjacent tracks on the tape T will be alternatingly written to and read from by the head 2. Read-while-write capability can be achieved by forming a counterpart head 2A (see FIG. 4) that also has an array of read and write transducers arranged in a linear side-by-side configuration, but with the order of the read and write elements reversed from the order of read and write elements in the head 2. In this way, when the heads 2 and 2A are arranged as shown in FIG. 4, there will be one write element and a one read element aligned along any given data track of the tape T. When the tape T travels in one direction, the number of data tracks that can be written in the read-while-write mode is equal to the total number of pairs of upstream write transducers and downstream read transducers. The converse is true when T reverses direction. To write all of the data tracks on the tape, the head will be stepped sideways along the tape in subsequent passes to align the read-write head pairs with the appropriate tape data tracks for that pass.

It will be appreciated that many other transducer arrangements would also be possible, including a merged head arrangement or a “piggy-back” head arrangement in which a pair of read and write transducers are formed at each data track position, but on different layers within the transducer carrier 6. As is known in the art, the merged head arrangement shares adjacent reader shield and writer pole materials while the piggy-back arrangement has a spacer between the adjacent reader shield and writer pole materials. The merged head construction is thus analogous to the head design used in DASD drives. Other construction alternatives would include an array of adjacent read transducers, and/or an array of adjacent write transducers.

Once the transducers 10 have been formed on the transducer carrier sublayer 22, an additional layer of material can be deposited over the transducers to complete the transducer carrier 6. The bonding pads 12 will also be completed as part of this processing, such that the pads are exposed on an interfacial surface 24 of the transducer carrier 6, as shown in FIG. 1.

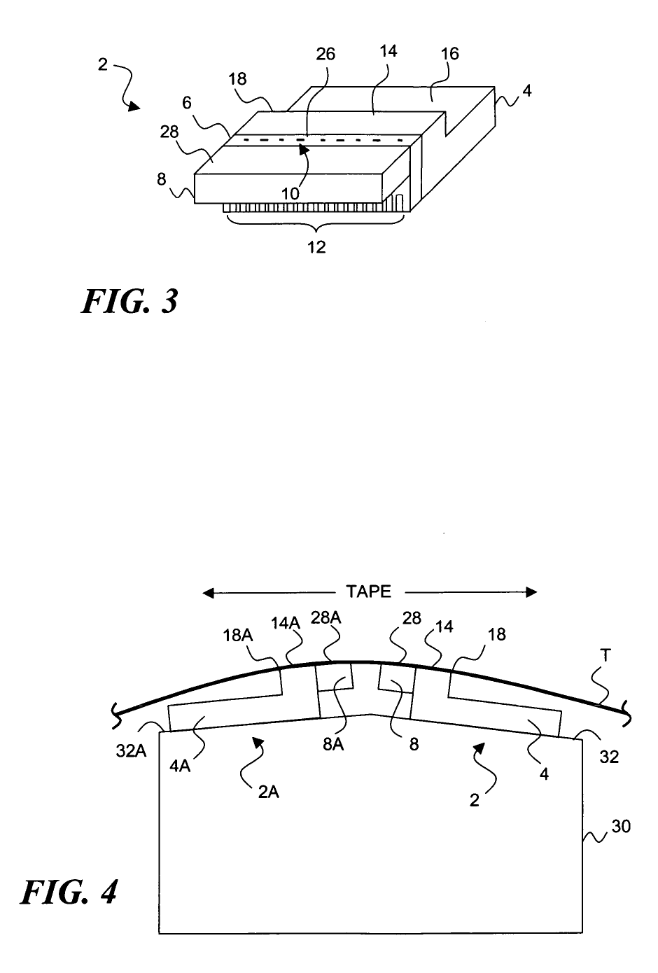

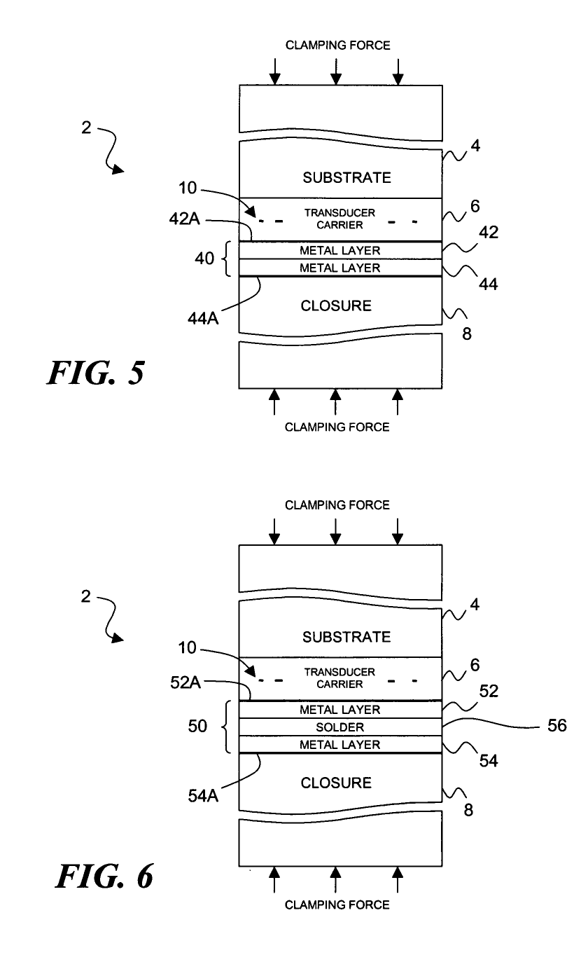

As shown in FIG. 3, the head 2 is completed by securing the closure 8 to the interfacial surface 24 of the transducer carrier 6. This procedure is described in more detail below relative to FIGS. 5-10. A lapping operation is performed following attachment of the closure 8 to the remainder of the head 2. This lapping operation defines the above-mentioned tape bearing surface 14 of the substrate 4. The lapping operation also defines a transducing surface 26 on the transducer carrier where the gaps of the transducers 10 are exposed for operative magnetic interaction with the tape T. The lapping operation additionally defines a tape bearing surface 28 on the closure 8. Insofar as the closure 8 is made a relatively hard material (e.g., AlTiC) its tape bearing surface 28 will withstand tape wear in the same manner as the tape bearing surface 14 of the substrate 4 (although the closure and substrate materials need not necessarily be the same). The tape bearing surface 28 of the closure 8 will thus act in concert with the tape bearing surface 14 of the substrate 4 to engage the tape T while protecting the relatively soft transducer carrier tape bearing surface 26 and the transducers 10 embedded therein.

FIG. 4 illustrates the head 2 and its counterpart 2A mounted to a head support structure 30. The support structure 30 may have a conventional U-beam construction to provide a central opening (not shown) for the electrical wiring that connects to the bonding pads 12. A pair of head mounting surfaces 32 and 32A on the support structure 30 carry the heads 2 and 2A while orienting the heads at a desired tape wrap angle.

As described by way of background above, the conventional closure bonding technique is based on the use of a thermosetting adhesive interposed between the relatively hard material of the closure and the relatively soft material of the transducer carrier 6. The resultant bond is susceptible to heat and humidity degradation and to swelling due to moisture absorption. A solution proposed herein is to replace the thermosetting adhesive bond with a metal-metal interconnection. Because metals do not adsorb appreciable amounts of water, they will not expand with exposure to humidity. The metal-to-metal interconnection is thus more resilient to attack by humidity. Furthermore, the interface between a metal-to-metal interconnection and the bonded materials is less susceptible to attack by humidity because of the inability for any significant amount of moisture to diffuse into the metal.

Turning now to FIG. 5, the formation of one exemplary metal-to-metal interconnection 40 between the closure 8 and the transducer carrier 6 is shown. The interconnection 40 comprises a first metal layer 42 formed on the transducer carrier 6 and a second metal layer 44 formed on the closure 8. The metal layers 42 and 44 are fused together by heating the layers to a point where their interfacial surfaces soften and bond to each other. The heating can be performed using any suitable technique, such as by placing the head structure in an oven or on a heating element, or by Joule heating with electrical current. Alternative heating techniques would include ultrasonic heating and pressure heating. To assist the fusing process, a compressive force may be applied to the head 2 to place the adjacent faces of the metal layers 42 and 44 under pressure. The compressive force could be applied using any suitable technique, including but not limited to, clamping with a clamping device, weighting with a weight, and self-weighting using the weight of the head components to provide the compressive force, etc. A suitable material that may be used for the metal layers 42 and 44 will be a metal whose softening temperature is not so high as to affect the existing components of the head 2 during the fusing operation, and which has sufficient wettability relative to the transducer carrier 6 and the carrier 8 to provide adequate bond strength. For a transducer carrier 6 made from alumina and a carrier 8 made from AlTiC, gold or an alloy thereof may be used to provide the metal layers 42 and 44. Ferrite materials, such as permalloy (nickel-iron) or sendust (aluminum-silicon-iron), could also be used, especially for the metal layer 42 on the transducer carrier 6 due to their shielding properties.

The metal layers 42 and 44 can be formed using conventional processes such as sputtering, vacuum deposition, plating, etc. If plating is used, seed layers 42A and 44A should be respectively formed on transducer carrier 6 and the closure 8 prior to applying the metal layers 42 and 44. A suitable seed layer material will be compatible with the metal layer material and will have good wettability relative to the transducer carrier 6 and the closure 8. If the metal layers 42 and 44 are gold, a thin (e.g., 100 Å) layer of a nickel-iron alloy could be used for the seed layers 42A and 44A. If these materials provide unacceptable magnetic effects, alternative seed layer materials, such as chromium or a copper-chromium alloy or tantalum, could be used. A seed layer between the gold material and the alumina or the AlTiC material may also provide better adhesion of the metal layers 42 and 44 to the transducer carrier 10 and the closure 8, respectively.

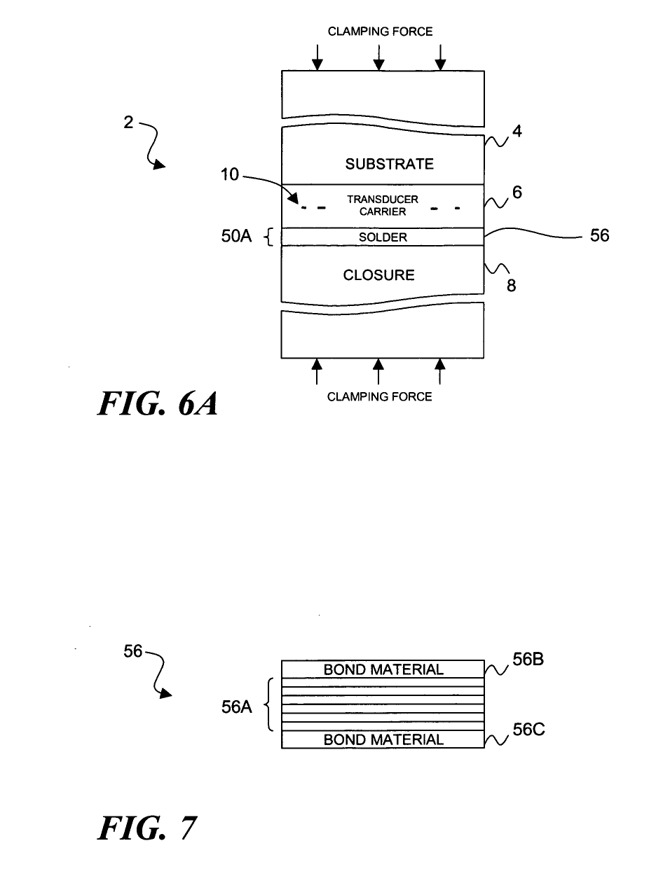

Turning now to FIG. 6, the formation of another exemplary metal-to-metal interconnection 50 between the closure 8 and the transducer carrier 6 is shown. The interconnection 50 comprises a first metal layer 52 formed on the transducer carrier 6 and a second metal layer 54 formed on the closure 8. The metal layers 52 and 54 may comprise the same materials as the metal layers 42 and 44 of FIG. 5, and they may be formed in the same fashion, including the use of plating seed layers 52A and 54A if a plating technique is employed to create the layers.

Unlike the metal layers 42 and 44, the metal layers 52 and 54 are fused together by interposing a metal solder bond material 56 between the layers and heating the solder layer to its melting point. The heating can be performed using any suitable technique, such as by placing the head structure in an oven or on a heating element, or by Joule heating with electrical current. Alternative heating techniques would include ultrasonic heating, pressure heating and reactive heating (see below). To assist the fusing process, a suitable compressive force (as described above) may be applied to the head 2 to place the solder layer 56 under pressure. A suitable material that may be used for the solder layer 56 will be a metal whose melting temperature is not so high as to affect the existing components of the head 2 during the fusing operation, and which has sufficient wettability relative to the metal layers 52 and 54 to provide adequate bond strength. For metal layers 52 and 54 made from gold or an alloy thereof, a solder layer 56 comprising materials such as bismuth, indium, lead, tin, silver, gold, cadmium, copper, antimony, zinc or alloys thereof, may be used. Such materials are present in commercially available solders. An exemplary solder melting point range would be from approximately 109° C. for bismuth-indium solder (e.g., Bi67/In33) to approximately 281° C. for gold-tin solder (e.g., Au80/Sn20). A larger temperature range could potentially also be used. In cases were additional wetting and adhesion between the solder layer 56 and the metal layers 52 and 54 is desired, the use of an interfacial tinning material may be considered. Such material can be deposited (as by sputtering) onto the metal layers 52 and 54 (or either of them) prior to applying the solder layer 56. The tinning material selection will depend on the materials that comprise the solder layer 56 and the metal layers 52 and 54. Exemplary tinning materials include, but are not necessarily limited to, silver, copper, palladium, and platinum, as well as alloys such as silver-platinum, silver-palladium, nickel-palladium, nickel-gold, nickel-gold-copper, and platinum-palladium-gold.

FIG. 6A illustrates a modified version 50A of the metal-to-metal interconnection 50 in which only the solder layer 56 is present, without the metal layers 52 and 54. The advantage of this design is that it has fewer processing steps insofar as the metal layers 52 and 54 need not be formed. However, the choice of solders may be limited to multilayer materials such as those described below. In that case, the solder layer 56 itself will provide metal layers that act as surrogates for the metal layers 52 and 54. In order to promote wetting and solder adhesion, any of the interfacial tinning materials described above with reference to FIG. 6 may be deposited (e.g., via sputtering) on the transducer carrier 6 and the closure 8 (or either of them) prior to interposing the primary solder material.

The solder layer 56 can be applied in wire, paste or glue form to the interface between the metal layers 52 and 56. Alternatively, the solder could be formed on the metal layers 52 and 56 (or either of them) as a solder deposition using a suitable deposition process, such as chemical vapor deposition, or via plating. An additional method would be to use commercially available sheet solders placed between the metal layers 52 and 54 to be bonded. One disadvantage of applying solder with conventional methods such as paste, wire or sheets is the difficulty of meeting thin bond lines (several microns). Another disadvantage of paste, wire or sheet solder is the extreme difficulty in avoiding solder material from spreading over these small devices and getting onto unwanted areas such as the tape bearing surface 26 or the bonding pads 12. A disadvantage of a solder deposition is that it involves the overhead of masking and stripping of unwanted materials.

A further alternative would be to create the solder layer 56 using a multilayer sheet solder material having a reactive laminate therein for melting the solder. For example, commercial multilayer reactive laminates are available with alternating layers of nickel and aluminum. The reactive laminate can be disposed between sheets of solder bonding material, such as indium. When an electrical current of suitable magnitude is passed through these materials, the reactive laminate melts the bonding material and a solder bond is formed when the melted materials resolidify.

A potential disadvantage of using prefabricated reactive laminates and bonding material sheets is that their manipulation and application at the extremely small size scale of transducing heads may be somewhat difficult. An alternative approach would be to use deposition processes to directly apply the same materials to create a custom reactive laminate solder layer 56. FIG. 7 is illustrative. It shows a solder layer 56 that comprises a multilayer solder deposition in which a reactive laminate 56A comprises alternating layers of nickel and aluminum. The bonding layers 56B and 56C on the reactive laminate 56A are comprised of indium. Other bonding layer materials, such as bismuth could also be used. This multilayer solder-reactive laminate-solder deposition could be formed on one of the pieces to be bonded (i.e., on one of the metal layers 52 or 54, or on either the transducer carrier 6 or the closure 8 without the metal layers) by sequentially depositing the desired materials. It will be appreciated that directly depositing the solder materials in this manner has the advantage that (1) minimal amounts of bonding materials are used, thus avoiding excess material spreading out to unwanted areas, (2) the thickness of the bonding material can be made very thin, and (3) complete coverage of the bonding surfaces is guaranteed. Once the multilayer solder deposition 56 of FIG. 7 is formed between the metal layers 52 and 56, the materials of the reactive laminate 56A can be melted by passing a suitable electrical current through them, thereby also causing the bonding layers 56B and 56C to melt and respectively fuse to the adjacent head components.

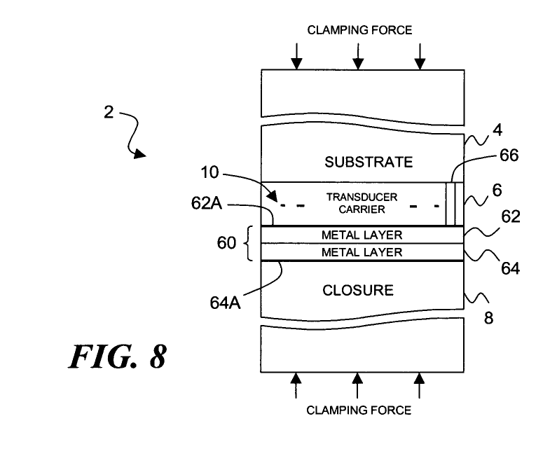

Turning now to FIG. 8, the formation of another exemplary metal-to-metal interconnection 60 between the closure 8 and the transducer carrier 6 is shown. The interconnection 60 comprises a first metal layer 62 formed on the transducer carrier 6 and a second metal layer 64 formed on the closure 8. The metal layers 62 and 64 may comprise the same materials as the metal layers 42 and 44 of FIG. 5, and they may be formed in the same fashion, including the use of plating seed layers 62A and 64A if a plating technique is employed to create the layers.

An additional feature of the construction shown in FIG. 8 is that a conductive connector 66 is formed to extend through the transducer carrier 6 and electrically connect the substrate 4 to the interconnection 60. This, in turn, electrically interconnects the substrate 4 to the closure 8 (which are electrically conductive if made from a material such as AlTiC), thereby ensuring that the substrate 4 and the closure 8 remain at the same electrical potential during head operation to prevent tribological charge imbalances and other electrical conditions that can perturb the transducers 10. The conductive connector 66 may be formed as a conductive post made of a suitable metal, such as gold, copper, nickel, tantalum, etc. The choice of the conductive connector and the geometry of the connector are dictated by the resistance desired between the closure and the substrate and by adherence to the different materials. Gold or copper would be two choices for a low resistance connection. Gold might be chosen over copper for resilience against corrosion. Tantalum with a long path length might be chosen if a higher resistance connection is desired.

The conductive connector 66 can be formed by etching a via through the transducer carrier 6, then depositing or plating conductive material into the via. A photo process can be used to define the etch area. If the transducer carrier 6 comprises a material such as sputtered alumina, the etching can be performed either with a hydroxide (NaOH or KOH) or an mild acid (H3PO4, e.g.). Both types of etchants have been used in wafer processes. If a plating process is used to form the conductive connector 66, a seed layer should be applied in the via prior to plating.

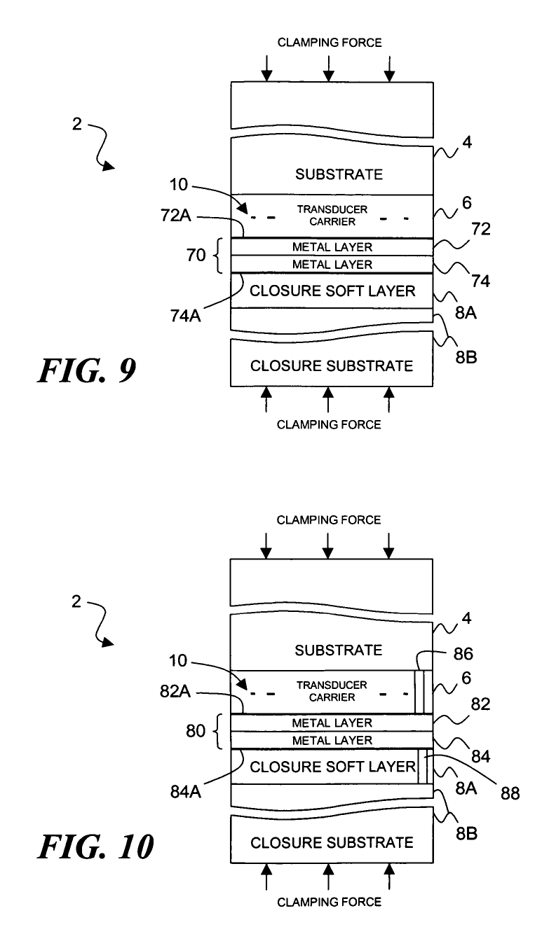

Turning now to FIG. 9, the formation of another exemplary metal-to-metal interconnection 70 between the closure 8 and the transducer carrier 6 is shown. The interconnection 70 comprises a first metal layer 62 formed on the transducer carrier 6 and a second metal layer 74 formed on the closure 8. The metal layers 72 and 74 may comprise the same materials as the metal layers 42 and 44 of FIG. 5, and they may be formed in the same fashion, including the use of plating seed layers 72A and 74A if a plating technique is employed to create the layers.

An additional feature of the construction shown in FIG. 9 is that the closure 8 is formed with a relatively soft layer 8A formed on a relatively hard closure substrate layer 8B. The closure layer 8A can be formed of a glassy material such as alumina. The closure layer 8B can be formed from a material such as AlTiC. The closure layer 8A can be deposited onto the closure layer 8B using the same conventional techniques used to deposit the transducer carrier 6 on the substrate 4. This two-layer construction of the closure 8 with the relatively soft layer 8A at the interconnection 70 may enhance the strength of the bond between the closure and the transducer carrier 6.

Turning now to FIG. 10, the formation of another exemplary metal-to-metal interconnection 80 between the closure 8 and the transducer carrier 6 is shown. The interconnection 80 comprises a first metal layer 82 formed on the transducer carrier 6 and a second metal layer 84 formed on the closure 8. The metal layers 82 and 84 may comprise the same materials as the metal layers 42 and 44 of FIG. 5, and they may be formed in the same fashion, including the use of plating seed layers 82A and 84A if a plating technique is employed to create the layers. The closure 8 also comprises the same relatively soft layer 8A and relatively hard closure substrate layer 8B shown in FIG. 9.

An additional feature of the construction shown in FIG. 10 is that a conductive connector 86 is formed to extend through the transducer carrier 6 and electrically connect the substrate 4 to the interconnection 80. Another conductive connector 88 is formed to extend through the closure layer 8A and electrically connect the relatively closure layer 8B to the interconnection 80. The conductive connectors 86 and 88 thus electrically interconnect the substrate 4 to the closure layer 8B, thereby ensuring that the substrate 4 and the closure layer 8B remain at the same electrical potential during head operation to prevent tribological charge imbalances and other electrical conditions that can perturb the transducers 10. The conductive connectors 86 and 88 may be formed using the same materials as the conductive connector 66 of FIG. 8, and they may be formed in the same fashion.

Although the preceding discussion of exemplary closure attachment techniques focuses on a single head 2, this is not intended to signify that the closure attachment process should be performed on a head-by-head basis. Although an assembly method that secures individual closures 8 to individual heads 2 is not to be precluded, persons skilled in the art will appreciate that the closure attachment operation will typically be performed at the wafer, quad or row bar level.

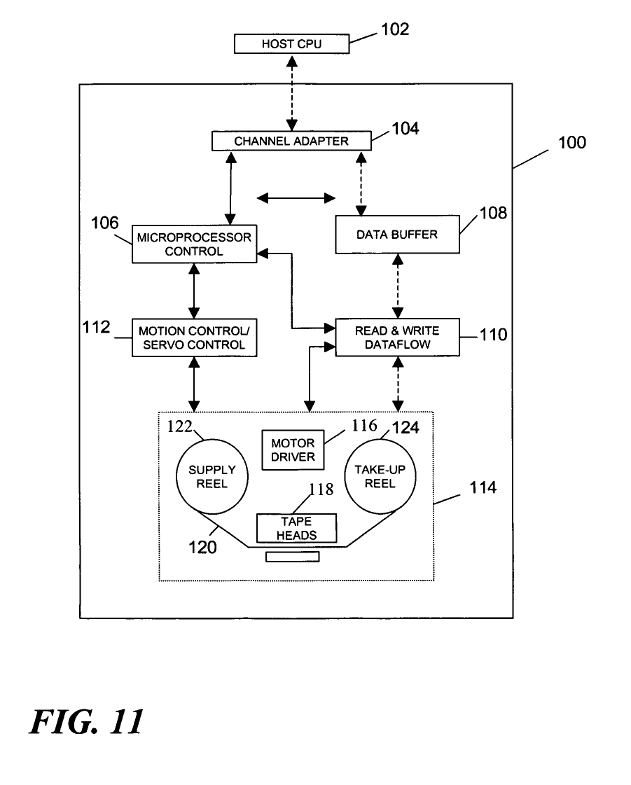

Turning to FIG. 11, the transducing head constructions herein described may be incorporated in a tape drive data storage device (tape drive) 100 for storing and retrieving data by a host data processing device 102, which could be a general purpose computer of other processing apparatus adapted for data exchange with the tape drive 100. The tape drive 100 includes plural components providing a control and data transfer system for reading and writing host data on a magnetic tape medium. By way of example only, those components may conventionally include a channel adapter 104, a microprocessor controller 106, a data buffer 108, a read/write data flow circuit 110, a motion control system 112, and a tape interface system 114 that includes a motor driver circuit 116 and a read/write head unit 118 comprising one or more transducing heads constructed in accordance with the present invention.

The microprocessor controller 106 provides overhead control functionality for the operations of all other components of the tape drive 100. As is conventional, the functions performed by the microprocessor controller 106 are programmable via microcode routines (not shown) according to desired tape drive operational characteristics. During data write operations (with all dataflow being reversed for data read operations), the microprocessor controller 106 activates the channel adapter 104 to perform the required host interface protocol for receiving an information data block. The channel adapter 104 communicates the data block to the data buffer 108 that stores the data for subsequent read/write processing. The data buffer 108 in turn communicates the data block received from the channel adapter 104 to the read/write dataflow circuitry 110, which formats the device data into physically formatted data that may be recorded on a magnetic tape medium. The read/write dataflow circuitry 110 is responsible for executing all read/write data transfer operations under the control of the microprocessor controller 106. Formatted physical data from the read/write data flow circuitry 110 is communicated to the tape interface system 114. The latter includes one or more transducing heads in the read/write head unit 118, and drive motor components (not shown) for performing forward and reverse movement of a tape medium 120 mounted on a supply reel 122 and a take-up reel 124. The drive components of the tape interface system 114 are controlled by the motion control system 112 and the motor driver circuit 116 to execute such tape movements as forward and reverse recording and playback, rewind and other tape motion functions. In addition, in multi-track tape drive systems, the motion control system 112 transversely positions the read/write heads relative to the direction of longitudinal tape movement in order to record data in a plurality of tracks.

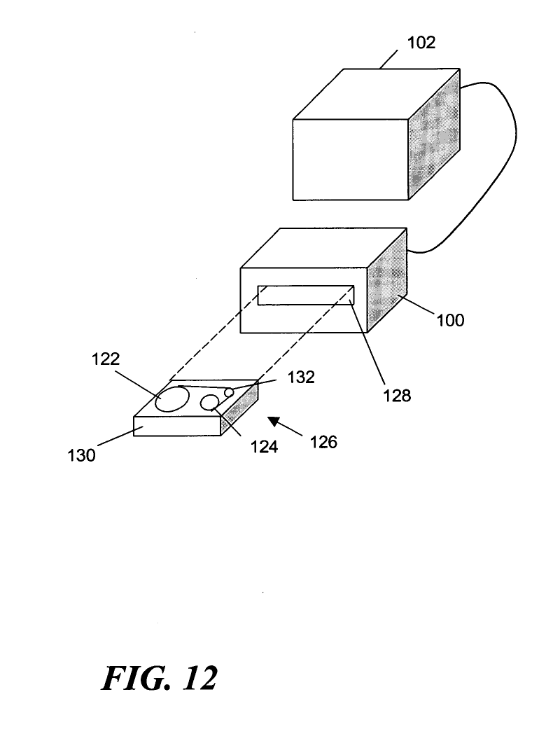

In most cases, as shown in FIG. 12, the tape medium 120 will be mounted in a cartridge 126 that is inserted in the tape drive 100 via a slot 128 in the tape drive 100. The tape cartridge 126 comprises a housing 130 containing the magnetic tape 120. The supply reel 122 and the take-up reel 124 are shown to be mounted in the housing 130, as is an exemplary capstan tape guide roller 132.

Accordingly, a transducing head and related fabrication method, together with a system that may be used for magnetic information storage, have been disclosed. While various embodiments of the invention have been shown and described, it should be apparent that many variations and alternative embodiments could be implemented in accordance with the teachings herein. For example, as earlier stated, the invention is not limited to tape drive applications and could be used in DASD devices, such as in cases where it is desirable to bond a closure to a disk drive transducing head (e.g., as part of a slider structure or for other reasons). Other magnetic storage applications for the invention may also arise. It is understood, therefore, that the invention is not to be in any way limited except in accordance with the spirit of the appended claims and their equivalents.

What is claimed is:

1. A transducing head, comprising:
a substrate comprising a relatively hard material;
a transducer carrier on said substrate comprising a material that is soft relative to said substrate and which embeds one or more transducer elements;
a closure on said transducer carrier comprising a relatively hard material; and
a metal-to-metal interconnection securing said closure to said transducer carrier.

2. A magnetic head in accordance with claim 1 wherein said interconnection comprises a first metal layer on said transducer carrier and a second metal layer on said closure, said first and second metal layers being fused together.

3. A magnetic head in accordance with claim 2 wherein said first and second metal layers comprise a metal solder bond material.

4. A magnetic head in accordance with claim 3 wherein said interconnection comprises a first metal layer on said transducer carrier, a second metal layer on said closure, and a metal solder bond material between said first and second metal layers, said first and second metal layers being fused together by way of said metal solder bond material.

5. A magnetic head in accordance with claim 4 wherein said metal solder bond material comprises plural layers.

6. A magnetic head in accordance with claim 5 wherein said plural layers respectively comprise metal solder bond material layers and reactive laminate layers.

7. A magnetic head in accordance with claim 5 wherein said metal solder bond material is combined with one or more tinning layers.

8. A magnetic head in accordance with claim 1 wherein said closure comprises a first layer of relatively soft material on a second layer of relatively hard material, said first closure layer carrying said second metal layer.

9. A magnetic head in accordance with claim 1 further including a conductive connector extending through said transducer carrier and electrically connecting said substrate to said interconnection.

10. A magnetic head in accordance with claim 8 further including a first conductive connector extending through said transducer carrier and electrically connecting said substrate to said interconnection, and a second conductive connector extending through said closure first layer and electrically connecting said closure second layer to said interconnection.

11. A method for fabricating a transducing head, comprising:
providing a substrate comprising a relatively hard material having formed thereon, a transducer carrier comprising a material that is soft relative to said substrate and which embeds one or more transducer elements;
securing to said transducer carrier a closure comprising a relatively hard material; and
said securing comprising forming a metal-to-metal interconnection between said transducer carrier and said closure.

12. A method in accordance with claim 11 wherein said interconnection is formed by depositing a first metal layer on said transducer carrier, a second metal layer on said closure, and fusing together said first and second metal layers while applying a compressive force.

13. A method in accordance with claim 12 wherein said first and second metal layers comprise a metal solder bond material.

14. A method in accordance with claim 13 wherein said interconnection is formed by depositing a first metal layer on said transducer carrier and a second metal layer on said closure, placing a metal solder bond material between said first and second metal layers, and fusing first and second metal layers together by melting said metal solder bond material.

15. A method in accordance with claim 14 wherein said metal solder bond material is selected from the group consisting of paste or wire solder, sheet solder, and solder depositions.

16. A method in accordance with claim 15 wherein a solder deposition is directly deposited using a deposition process and comprises a reactive laminate having alternating reactive layers and outer bonding material layers on said reactive laminate, and wherein said bonding comprises passing an electrical current through said reactive laminate to melt said reactive layers, causing them to melt said bonding material layers to form a bond when said reactive layers and said bonding layers resolidify.

17. A method in accordance with claim 12 wherein said closure comprises a first layer of relatively soft material deposited on a second layer of relatively hard material, and wherein said first metal layer is deposited on said first layer.

18. A method in accordance with claim 1 further including forming a conductive connector extending through said transducer carrier to electrically connect said substrate to said interconnection.

19. A method in accordance with claim 17 further including forming a first conductive connector extending through said transducer carrier to electrically connect said substrate to said interconnection, and a second conductive connector extending through said closure first layer to electrically connect said closure second layer to said interconnection.

20. A magnetic information storage system, comprising:
a transducing head adapted to operatively interact with a magnetically encodable medium;
a substrate in said transducing head comprising a relatively hard material;
a transducer carrier on said substrate comprising a material that is soft relative to said substrate and which embeds one or more transducer elements;
a closure on said transducer carrier comprising a relatively hard material; and
a metal-to-metal interconnection securing said closure to said transducer carrier.
